(19) United States
(12) Patent Application Publication
(10) Pub. No.: US 2008/0179136 A1
(43) Pub. Date: Jul. 31, 2008

(54) Multiple tear-away member energy absorber for personal fall arrestor

(75) Inventor: Richard R. Griffith, New Hartford, NY (US)

Correspondence Address: Hiscock & Barclay, LLP, One Park Place, 300 South State Street, Syracuse, NY, 13202-2078, US

(73) Assignee: STURGES MANUFACTURING CO., INC., Utica, NY (US)

(21) Appl. No.: 11/657,892

(22) Filed: Jan. 25, 2007

(51) Int. Cl. A62B 1/16

(52) U.S. Cl. 182/5

(57) ABSTRACT

An energy absorber for minimizing elongation upon deployment when used in a personal fall arresting system. The energy absorber contains at least two tear-away members in which each tear-away member includes upper and lower webbings that are each two ply members. The back ply of the upper webbing is mounted adjacent to the face ply of the lower webbing with this webbing being of about equal length and width. Exterior tear elements run back and forth sinusoidally between attachment points on the face ply of the upper webbing and the back ply of the lower webbing. Interior tear elements run back and forth sinusoidally between attachment points on the back ply of the upper webbing and the top ply of the lower webbing. The absorber, including the at least two tear-away members, can be made from a continuous strip of material wherein the tensile strength of each of the tear elements of each tear-away member is less than that of the attachment points.

### FIELD OF THE INVENTION

This invention relates to an improved energy absorbing device that is suitable for use in a personal fall arresting system, particularly in meeting various so-called “heavyweight” person standards, the device being characterized by a minimum permanent elongation for a standard maximum arresting force.

### BACKGROUND OF THE INVENTION

Workers who are obligated to work in high places such as on scaffolding, window ledges, and the like typically wear a body harness and/or a safety belt that is secured by a lanyard to some type of available anchorage. In the event the worker falls from a relatively high perch, he or she can reach a very high velocity in a matter of seconds. Depending upon the length of the lanyard, a falling worker's descent can be abruptly terminated causing serious bodily harm to the worker. Various shock or energy absorbing devices have been developed over the years to decelerate a worker's fall, and thus cushion the resulting impact shock. The shock absorber is typically made part of the lanyard connecting the worker's body harness or belt to an anchorage. One prevalent type of shock absorber is disclosed in U.S. Pat. No. 3,444,957 to Ervin, Jr., which involves a length of high strength webbing that is folded over itself a number of times with the adjacent folds being stitched together. The stitching is adapted to tear apart when placed under a given dynamic load to absorb the energy generated by the fall. This type of absorber is relatively lightweight, compact, and thus easily portable as well as being easily retrofitted into existing safety systems. This type of shock absorber will herein be referred to as a tear away type of energy absorber.

Various standards have been promulgated relating to personal fall arrestor systems, such as American National Standard Institute (ANSI) Standard Z359, issued in 1992 and reaffirmed in 1999 and the Canadian Standards Association (CSA) that issued a Canadian National Standard, Z-259.11-05, relating to Energy Absorbers and Lanyards in 2005, superseding a previous edition published in 1992 and reaffirmed in 1998. This standard addressed different safety systems and various methods for arresting falls of workers from high places. These standards are generally consistent in the most important features, as compared with the standards of other countries and relating to the amount of maximum arresting force and the amount of permissible elongation for a predetermined load. It should be noted that the above cited Canadian Standard is more stringent than most in that the requirement for dynamic drop load testing must be performed upon test specimens that have been conditioned for heat and moisture. To that end most, if not all, tear away absorbers in present day usage cannot consistently pass the dynamic drop test set out in the Canadian so called heavy person standard; Class E6, Heavyweight section.

In spite of the same parameters being measured, the above standards are somewhat different. For example, the above noted U.S. Standard originally required that a person weighing 100 kilogram (220 pounds) and dropped 1.8 meters (6 feet), absorb 1790 Joules (42,504 lbF), while not exceeding a maximum arrest force of 4.0 KN (900 lbs) and a maximum elongation of 42 inches. Canada, on the other hand, presently also further includes an additional heavier weight standard of 160 kilograms (350 pounds) for the same 1.8 meter (6 foot) drop, in which the energy absorbed must be 2825 Joules (67,076 lbF), while not exceeding a maximum arrest force of 6.0 KN (1349 lbs) and a maximum elongation of 1.75 meters (68.9 inches). Still further, the present European standards call for the same 100 kilogram weight as that of the U.S. Standard, but the required drop is much longer (4.0 meters —13.1 feet) than either of the preceding, requiring 3,942 Joules (93,161 lbF) be absorbed.

Regarding the potential for heavier workers on the job site, the United States is considering an increase to its weight requirement to in excess of 300 pounds and increasing its required drop distance to approximately 12 feet, thereby potentially increasing the required energy absorption to approximately 115,920 lbF, or 2.72 times the energy of the original standards requirement.

To dissipate this additional energy, the Canadian and European noted national standards currently allow an energy absorber to dissipate the energy at a higher peak force and for a longer elongation distance. However, it is of benefit to the worker having the fall to be arrested in the shortest possible distance in order to minimize the potential of encountering a rigid obstruction during the fall before the energy absorber has fully deployed.

Improved web-type, tear-away energy absorbers have been developed by Applicant, as described in pending U.S. patent application Ser. Nos. 11/237,157 and 11/439,015, the entire contents of which are herein incorporated by reference. However, it is believed, even with the further increasing drop test weights and elongation distances specified in the standards that increasing the tear out strength of these designs, as presently made, such as through increasing the tear element yarn size, increasing the number of tear elements and/or increasing the numbers of picks per inch, to successfully meet the increasing standards is not feasible.

First, if the yarn size of the element is increased, the current delicate balance between the tear elements and filling yarn (wefts) is disrupted. By their design, the filling yarn must be stronger than the tear element yarn in order to create shearing of the tear elements—that is, the entire principle of this energy absorber design. Filling failures are a cause of potential catastrophic failures. Increasing the size of both yarns results in the problem of creating webbing with too much density for the loom to weave successfully.

Second, retaining the size of the tear element yarn, but increasing the number of tear element yarns by, for example, increasing the width of the webbing pushes the loom close to the limits of production. Acceptable webbing is presently 1.75 inches wide while the loom limit is 2 inches. Therefore, only a 14 percent margin is available.

Finally, increasing the number of picks per inch upsets the balance of the webbing and pushes the limits of weaving. Tests have determined that increasing the picks from 19.8 picks per inch to a maximum of 24.0 picks per inch will only reduce the tear out distance, but does not produce an increase in the peak force to aid in energy dissipation needed by the ever increasing standards.

As a result of the above, there is a general need in the field to be able to develop energy absorbers that can accept greater maximum arresting (shock) forces while concurrently minimizing the elongation for a predetermined weight applied.

### SUMMARY OF THE INVENTION

It is therefore one object to improve personal fall arrest systems.

It is a further object to improve tear-away shock absorbers used in personal fall arrest systems.

It is still a further object to provide a web type, tear-away shock absorber that can pass the dynamic drop tests set out in various (i.e., American, Canadian and European) National Standards, thereby adequately covering safety requirements for personal fall arrest systems.

Another object is to provide an improved tear-away shock absorber for use in a personal fall arrest system that is simple in design, lightweight, flexible, and easily integrated into existing systems.

These and other objects are attained by an energy absorber suitable for use in a personal fall arresting system that includes at least two tear-away members, each of the tear-away members being secured to one another and including upper and lower two-ply webbings. Each webbing has a face ply and a back ply extending along the length of the webbing. The webbings are each mounted one over the other with the back ply of the upper webbing being adjacent to and aligned with the face ply of the lower webbing of each tear-away member. Exterior tear elements are also arranged to run back and forth sinusoidally between attaching points located on the face ply of the upper webbing and the back ply of the lower webbing of each tear-away member. Interior tear elements are arranged to run back and forth sinusoidially between attachment points located on the back ply of the upper webbing and the face ply of the lower webbing of each tear-away member. The tear elements of each of the tear-away members are designed to tear away, thereby decelerating the worker's rate of fall and thus remove the shock at impact, while the at least two tear-away members remain secured to one another.

According to one preferred version, a pair of tear-away members is provided, each of the tear-away members being integrally formed from a continuous strip having each of the upper and lower webbings. Opposing ends are formed at the center of the strip, each of the opposing ends including one of the webbings.

Providing an additional tear-away member without having to increase the width of an existing tear-away member or the strength of the yarns permits an overall increase in tear-out strength and also provides a considerable reduction in elongation. As a result, this design meets the aims of the above stated need in the face of ever increasing standards.

The attachment points, according to one version, are formed from wefts made from a polyester yarn.

The tear elements of each of the tear-away members can be coated with a material for reducing yarn on yarn abrasion, especially after exposure to moisture, making the herein described energy absorber more effective over temperatures ranging from ultra-cold to elevated. The tensile strength of the interior and exterior tear elements of each tear-away member is less than that of each of the attachment points.

According to another exemplary aspect, there is provided an energy absorber for use as a component part of a personal fall arresting system, the energy absorber comprising at least two tear-away members, each of the tear-away members including a two-ply upper webbing having face ply and back ply each containing uniformly spaced wefts that pass laterally through warps located in the plies of said upper webbing, a two-ply lower webbing having face ply and back ply each containing uniformly spaced wefts that pass laterally through warps located in the plies of the said lower webbing, said webbing being mounted one over the other with the back ply of the upper webbing located adjacent to and in alignment with the face ply of the lower webbing with the wefts in the two back ply being spaced about midway between the wefts in the two face plies a number of continuous exterior tear fibers, each of the tear fibers running back and forth over the wefts contained in the face ply of the upper webbing and adjacent wefts contained in the back ply of the lower webbing to establish a sinusoidal-shaped exterior binder and a number of continuous interior tear fibers, each of the interior tear fibers running back and forth over the wefts contained in the back ply of the upper webbing and adjacent wefts contained in the face ply of the lower webbing to establish a sinusoidal-shaped interior binder.

### BRIEF DESCRIPTION OF THE DRAWINGS

For a better understanding, reference will be made in the disclosure below with regard to the accompanying drawings, wherein:

FIG. 1 is a partial perspective view, illustrating a tear-away web type energy absorber made in accordance with an exemplary embodiment;

FIG. 2 is an enlarged partial view of the energy absorber of FIG. 1;

FIG. 3 is an enlarged partial sectional view taken along lines 3-3 of FIG. 1, further showing the construction of one of the tear-away members of the energy absorber;

FIG. 4 is a further enlarged view of the energy absorber of FIGS. 1 and 2;

FIG. 5 depicts the energy absorber of FIGS. 1-4, as connected in a typical use condition as part of a lanyard;

FIG. 6 is a partial front elevation of a test stand used for performing dynamic drop tests upon specimens of the energy absorber, such as those according to the design illustrated in FIGS. 1-4;

FIG. 7 is a graph plotting load against time illustrating a typical test result relating to the energy absorber made in accordance with FIGS. 1-4 and tested using the test stand of FIG. 6; and

FIG. 8 depicts a listing of additional measured force and elongation data for a batch of test specimens utilizing the multiple tear-away member energy absorber of FIGS. 1-4, that are tested in accordance with a predetermined test standard using, for example, the test stand of FIG. 6.

### DETAILED DESCRIPTION

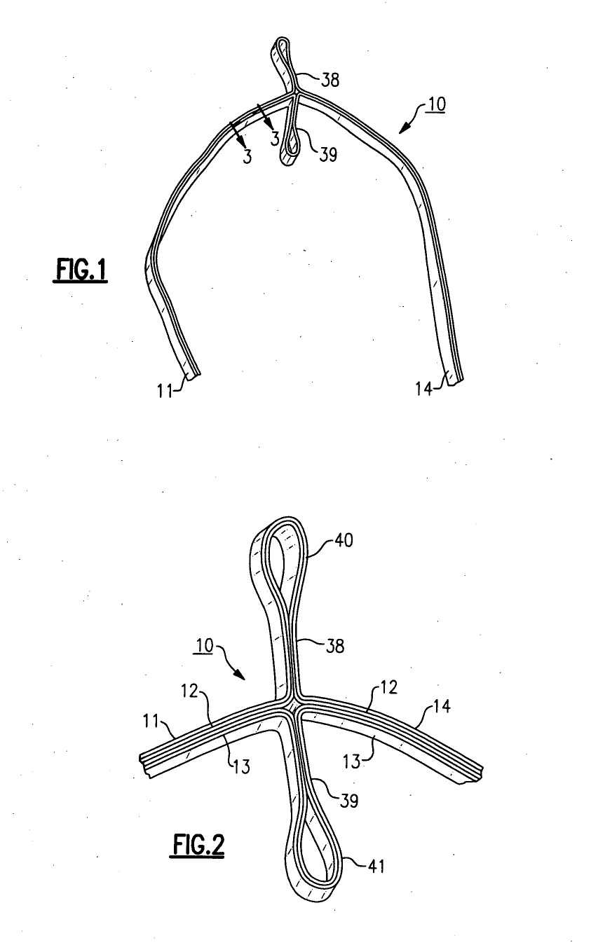

Turning first to FIG. 1, there is illustrated a web-type, tear-away energy absorber, generally referenced 10, in accordance with an exemplary embodiment. The absorber 10 illustrated relates to a test specimen that is used for verification testing with regard to at least one predetermined standard. The herein described energy absorber 10 is defined by a pair of tear-away members, hereinafter referred to as first and second tear-away members 11 and 14, respectively. The tear-away members 11, 14 are constructed according to this embodiment from a single member or strip that is configured in a manner as described below.

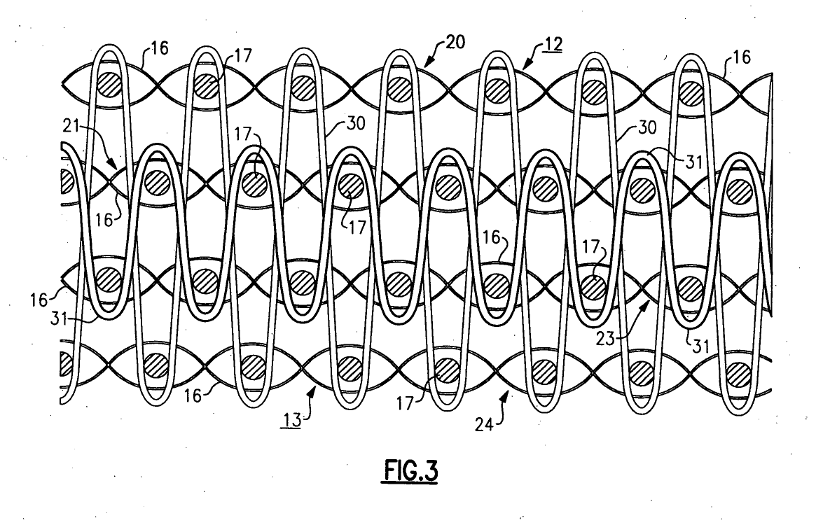

Referring specifically to FIG. 2 and more particularly to the sectioned view of FIG. 3, each of the first and second tear-away members 11, 14 comprise two ply webbings that include an upper webbing 12 and a lower webbing 13. The two webbings 12, 13 are preferably woven from high tenacity polyester yarns. Each ply further includes a series of longitudinally extended ends having a series of warps 16 spaced along its length and filling yarn or wefts 17 that pass laterally throughout the warps to transverse the width of the yarn.

Only one (i.e., the first) tear-away member 11 of the energy absorber 10 is herein described. The second tear-away member 14 is similarly constructed and therefore further description of the interior construction of that member is not required. To that end, the upper webbing 12 contains a face ply 20 and a back ply 21. The lower webbing 13 similarly includes a face ply 23 and a back ply 24. The wefts 17 that are contained in the back ply 21, 24 of each webbing 12, 13 are arranged in assembly so that they are located about midway between the wefts contained in the face ply 20, 23 of each webbing. The upper and lower webbings 12, 13 are of the same length and width. In assembly, the two webbings 12, 13 of the tear-away member 11 is superimposed in alignment one over the other with the back ply 21 of the upper webbing 12 being mounted adjacent to the face ply 23 of the lower webbing 13. As illustrated in FIG. 3, the wefts 17 in the two face plies 20, 23 are placed in commonly shared vertical rows and the wefts in the two back plies 21, 24 are also placed in commonly shared vertical rows with the rows containing the back ply wefts being located about midway with respect to the rows containing the face ply rows.

The two pieces of webbing 12, 13 are woven together using a series of binders that are formed by continuous strands of tear elements. These tear elements include what will herein be referred to as an exterior tear element 30 and interior tear element 31. The tear elements 30, 31, according to this embodiment, are fabricated of high tenacity polyester fibers, although other suitable fibers, such as nylon or the like, having similar properties may be used without departing from the teachings related herein. The exterior tear element 30 runs back and forth in a sinusoidal manner between attachment points 17 on the face ply 20 of the upper webbing 12 and the back ply 24 of the lower webbing 13. The interior tear element 31 runs back and forth in a sinusoidal configuration between attachment points 17 on the back ply 21 of the upper webbing 12 and the face ply 23 of the lower webbing 13. As illustrated in FIG. 3, the laterally extended wefts 17 in each of the plies serve as the attachment points for both sets of tear elements. The tensile strength of the two binders is less than that of the wefts 17 and as will be explained in greater detail below, the tear elements are designed to tear out under load before the wefts 17 will rupture. According to one version, the wefts 17 are made from a polyester or a para-aramid yarn. For example, para-aramid yarns such as those manufactured under the trade names of Kevlar by the E. I. DuPont de Nemours Company and Twaron by the Teijin Group have been deemed as acceptable for this purpose. It should be readily apparent, however, that other alternative materials can be used, provided that the tensile strength of the wefts 17 exceeds the tensile strength of the exterior and interior tear elements 30, 31. A lock stitch (not shown) of a contrasting color polyester yarn is added to the knit edges of each webbing 12, 13.

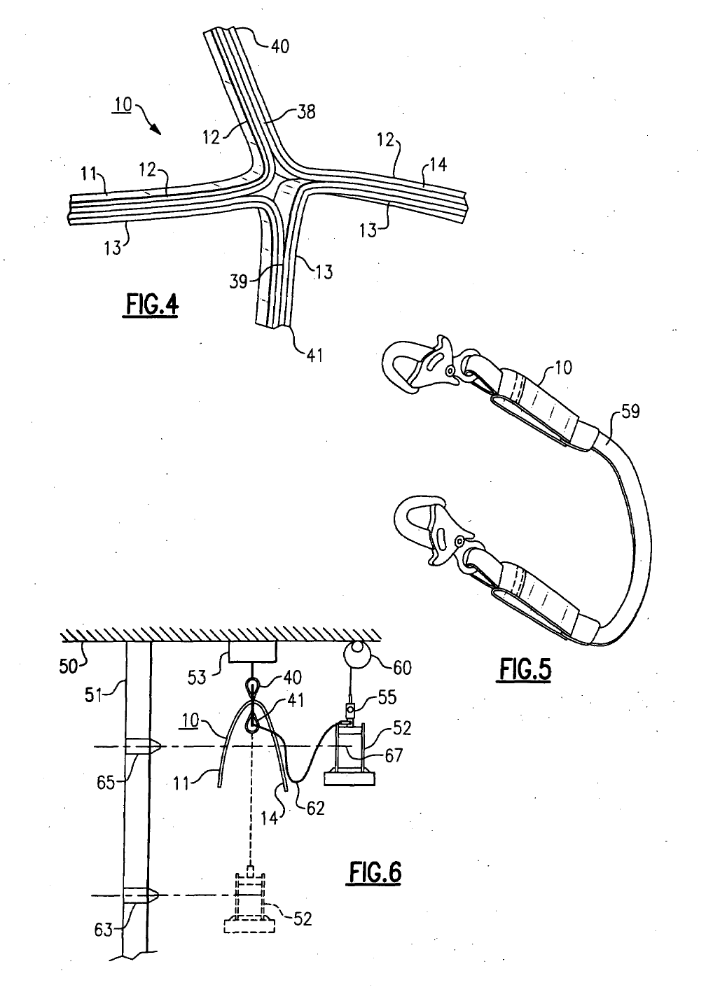

As noted herein and referring to FIGS. 1, 2 and 4, each of the first and second tear-away members 11, 14 are created on a continuous strip that includes each of the upper and lower webbings 12, 13. At the center of the strip between the two tear-away members 11, 14, each of the upper and lower webbings 12, 13 are separated from one another and placed in an overlapped fold, thereby forming a pair of opposing ends 38, 39. Each of these opposing ends 38, 39 are attached, as shown in the test specimen depicted in FIGS. 1, 2 and 4, into a pair of respective opposing loop connectors 40, 41. The overlapped folds (opposing ends 38, 39) of each of the webbings 12,13 are stitched within each of the loop connectors 40, 41, thereby securing the folds in place and interconnecting the two tear away members 11, 14.

It was found through further testing that performance of an energy absorber constructed in the manner described above can be further enhanced by coating the interior and exterior binders with a material that improves the binder's yarn on yarn abrasion resistance as well as resistance to exposure to temperature extremes and to moisture. One such coating material that performed well in practice was a siloxane-based overlay that formed a durable polymeric network upon the binders that is commercially available from Performance Fibers, Inc. under the trade name SEAGARD. It is believed that other polymer materials which have a high lubricity will perform equally as well in practice in avoiding high yarn on yarn abrasion. In a further embodiment, the wefts of the two webbings 12, 13 of each of the tear-away members 11, 14, FIG. 1, can also be coated with the above noted material to further enhance the performance of the energy absorber.

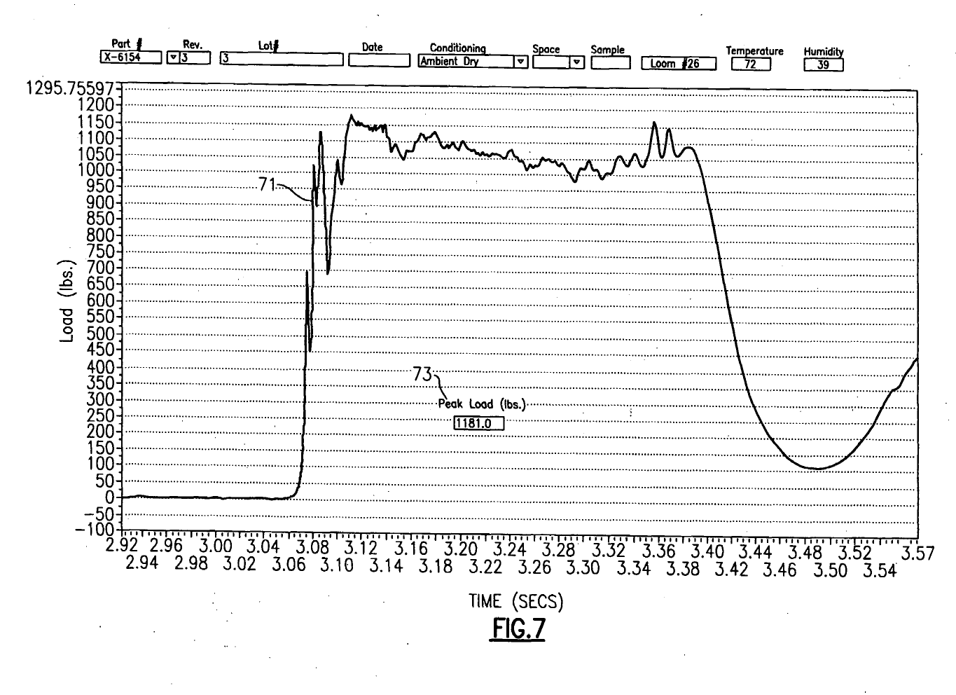

As noted, the two opposing ends 38 and 39 will typically be provided with connectors for attaching the energy absorber 10 to a personal fall arrest system. Referring for example, to FIG. 5, the energy absorber 10 can be placed in series with a lanyard 59 for coupling the worker harness or safety belt to a suitable anchorage such as a stationary structural element, the latter element having sufficient strength to arrest a worker's descent in the event of a fall. The lanyard 59 provides sufficient length to permit the worker (not shown) to move about with a reasonable amount of freedom. In the event of a fall, the lanyard 59 will play out until it becomes taut at which time the dynamic load of the falling worker is taken up by the energy absorber 10 whereupon the binders 30, 31 (FIG. 3) begin to tear away absorbing the kinetic energy generated by the fall. The rate of the fall is thus decelerated, lowering the force acting upon the worker's body as the fall is being arrested.

Applicant, in order to insure that it is in compliance with the National Standards of various countries, including those of the United States, Europe and Canada, has constructed a test stand for dynamically testing sample absorber specimens 10 of the type described above. As illustrated in FIGS. 1 and 2, the energy absorber specimens are equipped at each end with high strength non-elastic loop connectors 40 and 41 that are sewn into the center open section of the absorber 10. According to this embodiment, these connectors 40, 41 will not pull out or elongate when experiencing dynamic load well in excess of 2000 pounds.

With further reference to FIG. 6, the test stand contains a fixed anchorage consisting of a horizontal cross beam 50 that is supported upon a pair of spaced apart vertical columns, one of which is depicted at 51. Although not shown, the cross beam 50 is suspended above a drop pit containing a deep layer of sand or other suitable material. During a test, the two loop connectors 40, 41 of the test specimen energy absorber 10 are initially provided with shackles and the shackle of one loop connector 40 is connected to an anchorage point. A representative (i.e., 10 pound) weight is suspended from the remaining loop connector 41 and the distance between the two loop connector fold over points is measured and recorded. A load cell 53 is securely mounted upon the center of the cross beam 50 and one of the energy absorber loop connectors 41 is attached to the load cell 53 by a suitable eyebolt (not shown) or other means.

An air-activated quick release mechanism 55 is connected to a one hundred sixty kilogram (353 lb) weight 52 by means of a suitable shackle (not shown). The weight 52 is then raised by a hoist 60 which is used to raise the weight to a desired height. A wire rope lanyard 62 of appropriate length (e.g., 2240 mm) includes thimble eyes or other equivalent structure to attach the weight 52 to the remaining loop connector 41 of the test specimen 10 using a shackle (not shown). The weight 52 is next lowered by the hoist 60 until the test weight is supported entirely by the test lanyard 62. According to this specific test stand, a first laser 63 which is adjustably mounted on one of the support columns 51 is vertically adjusted so that its horizontal beam illuminates a horizontal line 67 located on the weight 62. A second laser 65, which is also vertically adjusted upon the column, is set at a predetermined height (e.g., 6 feet) above the first laser 63 and the weight 62 is lifted by the hoist 60 until the beam of the second laser illuminates the line on the weight. Other techniques, however, can be utilized.

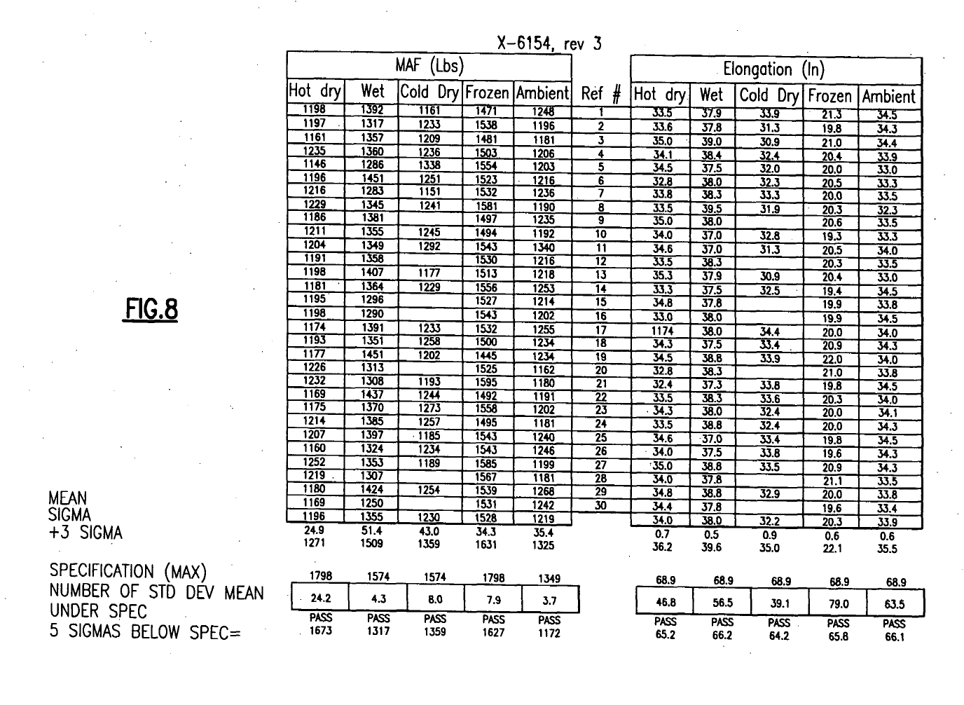

At this time, the quick disconnect mechanism 55 is released and the weight 52 is allowed to drop, thereby activating the attached energy absorber 10, whereupon the tear elements 30, 31 of each of the first and second tear away members 11, 14 breaks away, decelerating the falling weight and bringing the weight to a controlled halt. The distance between the foldover points of the two loop connectors 40, 41 upon the played out energy absorber 10 is then measured and the permanent elongation of the absorber is calculated by subtracting the initially recorded foldover distance prior to the absorber 10 being activated and the final foldover distance measurement. The elongation tear length of the energy absorber 10 is then recorded and the peak load and average load data are graphically provided by the readout of the load cell 53. A sample graphical representation is shown in FIG. 7.

For purposes of example and in order to meet the dynamic performance (drop test) standards set out by the Canadian National Standards (CSA) for an energy absorber for a heavyweight individual, the absorber must not elongate beyond 1.75 meters (68.9 inches) from its initial length and the standard maximum arresting force (MAF) shall not exceed 6.0 (1349 lbs) based upon a weight of 160 kilograms (353 lbs).

In order to meet the additional environmental requirements of the above referred to Canadian National Z-259 Standard, test specimens of a given energy absorber design must pass a number of dynamic drop tests that are carried out under different conditions, as follows. Comparable test specimens are constructed having the above design that are constructed to handle each of these versions:

1) Ambient testing of a test specimens at 20° C., ±2° C., wherein for the 160 kg compatible version, the maximum arresting force does not exceed 6.0 kN and the permanent elongation does not exceed 1.75 meters;

2) Elevated temperature testing of a test specimen that has been conditioned at 45° C.,±2° C., for a minimum of eight hours. The test is carried out within five minutes after conditioning is completed wherein for the 160 kg compatible version, the maximum arresting force does not exceed 8.0 kN and the permanent elongation does not exceed 1.75 meters;

3) Wet testing of a test specimen that has been immersed in water at 20° C.,±2° C., for a minimum of eight hours. Under this test, the specimen of the 160 kg compatible version, shall not exceed a maximum arresting force of 7.0 KN and the permanent elongation does not exceed 1.75 meters;

Cold testing of a test specimen is also carried out wherein the specimen is conditioned at a temperature of −35° C.,±2° C., for eight hours and tested within five minutes upon completion of the conditioning. For the 160 kg compatible version, the maximum arresting force shall not exceed 7.0 kN and the permanent elongation shall not exceed 1.75 meters; and

Lastly, testing of an energy absorber test specimen 10 that has been exposed to both water and a low temperature is carried out. Initially, the specimen is immersed in water at 20° C.,±2° C., for a minimum of eight hours. The specimen may be allowed to drain for up to fifteen minutes and is then conditioned at −35° C.,±2° C., for a minimum of eight hours. Within five minutes after the completion of conditioning, the specimen is tested and for the 160 kg compatible version, the maximum arresting force shall not exceed 8.0 kN and the permanent elongation shall not exceed 1.75 meters.

A varied number of specimens 10, FIG. 1, were tested in the noted test stand of FIG. 6 in an effort to identify an energy absorber that will consistently meet the dynamic performance tests set out by CSA Z-259.11-05. Each of these specimens commonly included a pair of tear-away members 11, 14, FIG. 1, in which each of the tear-away members further incorporated the double two ply webbing arrangement described above. At least one energy absorber configuration was identified that consistently met the standards for a dynamic drop test. According to this configuration, each of the upper and lower webbings 12, 13 of this absorber test specimen 10 had a length of about 22 inches and a width of about 1.5 inches. In this configuration, each face and back ply of either the upper or lower webbing layer contained 46 ends of 1300 denier two-ply high tenacity polyester fibers while the wefts 17 contained in each ply were fabricated of 1300 denier high tenacity polyester. Each webbing 12, 13 as used in the tear-away members 11, 14 further contained 22 ends of exterior binders and 22 ends of interior binders. The binders were each fabricated of 1000 denier single-ply high tenacity polyester fibers.

FIG. 7 is a graphic representation 71 showing a typical test result of an energy absorber 10 constructed as noted above that was subjected to a dynamic performance test conducted in accordance with the above noted CSA Z-259.11-05 standard wherein at the time of testing, the relative humidity was 39% and the ambient temperature was 79° F. The illustrated graph 71 plots the load, as measured in pounds exerted upon the specimen against time, as measured in seconds. According to this load test, the specimen elongated 34.4 inches with a peak load (maximum arresting force (MAF)) of 1181.0 pounds, shown at 73.

A tabular summary of test results for a batch of test specimens 10, FIG. 1, and made as specifically noted above, is presented in FIG. 8, including the one shown in FIG. 7, for various conditions, including elevated and dry conditions, wet conditions, cold and dry conditions, frozen conditions, and ambient conditions. A total of one hundred and forty three (143) test specimens are listed. Each of the measured maximum arresting force (MAF), as measured in pounds, and permanent elongation of the test specimen, as measured in inches, are listed in the illustrated table. Each of the results are compared for each load condition with the specification standard value and are statistically analyzed by means of calculating a mean sigma for each category and computing the number of standard deviations from +3 sigma. Of particular note is that though the value of the maximum arresting force values is within the standard requirement for each tested specimen, the extent of permanent elongation is effectively minimized as compared to the requirement, having a value consistently about one half of the standard allowance, using multiple tear-away members.

### PARTS LIST FOR FIGS. 1-8

10 energy or shock absorber
11 first tear-away member
12 upper webbing
13 lower webbing
14 second tear-away member
16 warps
17 filling yarn or wefts
20 face ply, upper webbing
21 back ply, upper webbing
23 face ply, lower webbing
24 back ply, lower webbing
30 exterior tear elements
31 interior tear element
38 opposing end
39 opposing end
40 loop connector
41 loop connector
50 horizontal crossbeam
51 vertical column
52 standard weight
53 load cell
55 air-activated quick release mechanism
59 lanyard
60 hoist
62 test lanyard
63 first laser
65 second laser
67 horizontal line
71 graph
73 peak load value

While this invention has been particularly shown and described with reference to the preferred embodiment in the drawings, it will be understood by one skilled in the art that various changes in its details may be effected therein without departing from the intended teachings. For example, the embodiment of FIGS. 7 and 8 refer to a energy absorber that meets certain load and elongation requirements using two tear-away members that are integrally connected together in a strip. It should be apparent that additional tear-strip members could be included wherein each may be secured to produce a desired arresting effect for a worker, but whose construction can permit separate connection. It should be further apparent that the preceding design can be applied to numerous load conditions.

What is claimed is:

1. An energy absorber for use as part of a personal fall arresting system, said energy absorber comprising:
at least two tear-away members, each of said at least two tear-away members further including:
upper and lower two-ply webbings, each of said webbings having a face ply and a back ply extending along the length of the webbing, said webbings being mounted one over the other with the back ply of the upper webbing being adjacent to the face ply of the lower webbing;
exterior tear elements running back and forth sinusoidally between attachment points on the face plies of the upper webbing and the back plies of the lower webbing; and
interior tear elements running back and forth sinusoidally between attachment points on the back plies of the upper webbing and the face plies of the lower webbing.

2. The energy absorber of claim 1, including two tear-away members, each of said tear-away members being integrally formed on a continuous strip.

3. The energy absorber of claim 2, wherein including a pair of opposing ends formed at the center of said continuous strip, each of said opposing ends including one of said webbings.

4. The energy absorber of claim 3, wherein each of said opposing ends are formed into an overlapping folded section, each said section being oppositely disposed from one another and retained by a connector.

5. The energy absorber of claim 1, wherein the attachment points are evenly distributed along the width of selected ends of each ply.

6. The energy absorber of claim 1, wherein each tear element is fabricated of a continuous high tenacity polyester fiber.

7. The energy absorber of claim 6, wherein the tear elements are covered with a coating for protecting the tear elements against fiber to fiber wear, temperature extremes, and moisture.

8. The energy absorber of claim 7, wherein said coating is a siloxane-based material.

9. The energy absorber of claim 7, wherein each tear element is looped around wefts that pass laterally through warps ends contained in said face plies and said back plies of the upper and lower webbings.

10. The energy absorber of claim 9, wherein the tear elements are fabricated of a material that will rupture before the face weft and the back weft of the upper and lower webbings when the energy absorber is placed under load.

11. An energy absorber for use as a component part of a personal fall arresting system that includes:
at least two tear-away members, each of said tear-away members including:
a two-ply upper webbing having a face ply and a back ply each containing uniformly spaced wefts that pass laterally through warps located in the plies of said upper webbing;
a two-ply lower webbing having a face ply and a back ply each containing uniformly spaced wefts that pass laterally through warps located in the plies of the said lower webbing;
said webbing of each tear-away member being mounted one over the other with the back ply of the upper webbing located adjacent to and in alignment with the face ply of the lower webbing with the wefts in each back ply being spaced about midway between the wefts in each face plies;
a number of continuous exterior tear fibers, each of said exterior tear fibers running back and forth over the wefts contained in the face ply of the upper webbing and adjacent wefts contained in the back ply of the lower webbing to establish a sinusoidal-shaped exterior binder; and
a number of continuous interior tear fibers, each of said interior tear fibers running back and forth over the wefts contained in the back ply of the upper webbing and adjacent wefts contained in the face ply of the lower webbing to establish a sinusoidal-shaped interior binder.

12. The energy absorber of claim 11, including two tear-away members, each of said tear-away members being integrally formed on a continuous strip.

13. The energy absorber of claim 12, wherein including a pair of opposing ends formed at the center of said continuous strip, each of said opposing ends including one of said webbings.

14. The energy absorber of claim 13, wherein each of said opposing ends are formed into an overlapping folded section, each said section being oppositely disposed from one another and retained by a connector.

15. The energy absorber of claim 11, wherein said binders are coated with a coating for reducing fiber to fiber wear and which provides protection against temperature extremes and moisture.

16. The energy absorber of claim 15, wherein said coating is a siloxane-based material that forms a polymeric coating upon the binders.

17. The energy absorber of claim 11, wherein each ply contains about 46 face ends and about 46 back ends.

18. The energy absorber of claim 14, wherein each ply contains about 22 exterior tear fibers and about 22 interior tear fibers.

19. The energy absorber of claim 12, wherein said warps are fabricated of 1300 denier two-ply polyester fibers and wefts are fabricated of 1300 denier single-ply high tenacity polyester fibers and the binders are fabricated of a 1000 denier single-ply high tenacity polyester fibers.

20. The energy absorber of claim 12, wherein the wefts of the upper and lower webbings are also coated with a coating for reducing fiber to fiber wear and protects against temperature extremes and moisture.

21. The energy absorber of claim 6, wherein the tear elements are fabricated of a material that will rupture before the face weft and back weft of the upper and lower webbings when the absorber is placed under load.

22. The energy absorber of claim 14, wherein at least one of said opposing ends are connected to a lanyard of said fall arresting system.
